(19) United States
(12) Patent Application Publication
(10) Pub. No.: US 2003/0160758 A1
(43) Pub. Date: Aug. 28, 2003

(54) Optical tracking device for computers

(76) Inventor: A-Man Hung, Dan Shuei Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/082,275

(22) Filed: Feb. 26, 2002

(51) Int. Cl. G09G 5/08

(52) U.S. Cl. 345/157

(57) ABSTRACT

An optic tracking device includes a movable body having a bottom movably supported on a pad. The bottom of the body defines a cavity for accommodating an optic sensor comprised of a number of photo transistors encased in a transparent casing. A light emitting element is mounted in the body to project light to the pad at a position substantially below the optic sensor. The light is reflected by the pad and detected by the optic sensor. The pad forms a number of light reflective zones spaced from each other and surrounded by a light absorbing area whereby when the body is moved on the pad, light reflected from the pad and detected by the optic sensor changes with the movement of the body that alternately passes through the light reflective zones and different portions of the light absorbing area. The optic sensor converts the light reflected from the pad into an electrical signal, which is processed by a signal processing circuit to generate data corresponding to moving speed and direction of the body.

### FIELD OF THE INVENTION

The present invention generally relates to a computer tracking device, and in particular to an optic tracking device comprising a body retaining optic elements manually operable on a pad having a surface on which discrete zones of high reflectivity are formed.

### BACKGROUND OF THE INVENTION

Optic mice are a prevailing computer tracking device for controlling the movement of a cursor on a display screen. The tracking devices are a required peripheral device of computer systems. Conventionally, an optic mouse is comprised of an optic image detection device and a light source for emitting light. The optic mouse is operated on a flat surface and light emitted from the light source is projected onto the flat surface, such as a desk or a mouse pad, and reflected back to the optic mouse. The reflected light forms image that is detected by the optic image detection device. The image detected by the image detection device changes with the movement of the optic mouse and calculation is performed to determine the vector of movement and the coordinates of the optic mouse.

The conventional optic mouse, however, suffers the following disadvantages:

(1) The image detection device that is employed in the conventional optic mouse comprises a lens for receiving the light of the image whereby the image detection device is susceptible to error caused by incorrect distance between the lens and the surface that reflects the light, such as the optic mouse is lifted away from the desk, and error of the cursor movement may raise.

(2) The conventional optic mouse cannot properly operate when it is placed on a surface having a very high reflectivity because the high reflectivity causes the images detected by the mouse to be all identical during the movement of the mouse whereby the mouse cannot provide data for calculation of movement vector of the mouse.

(3) The conventional optic mouse has a sophisticated structure and requires precise calibration of the lens focus. Such a calibration is generally very time- and labor-consuming. Thus mass production is difficult.

(4) The cost of the conventional optic mouse is high since the optic detection device is costly and is not readily available in the market. Furthermore, the maintenance cost of the conventional optic mouse is also high due to the precise calibration required for the optic image device.

It is thus desirable to have an improved optic tracking device for overcoming the above-mentioned problems.

### SUMMARY OF THE INVENTION

Accordingly, an object of the present invention is to provide an optic tracking device comprising a photo transistor for receiving and detecting reflected light from a pad to replace the sophisticated and costly optic image detection device so as to eliminate the random movement of the screen cursor caused by improper positioning of the optic image detection device.

Another object of the present invention is to provide an optic tracking device comprising a body movably supported on a pad having a number of spaced light reflective zones formed thereon whereby incorrect detection caused by surface flaws of the support surface of the movable body can be neglected.

Another object of the present invention is to provide an optic tracking device having an optic sensor comprised of a number of photo transistors encased in a transparent casing whereby calibration of the conventional optic image detection device is no longer required which reduces costs of the optic tracking device.

A further object of the present invention is to provide an optic tracking device wherein an optic sensor comprised of low cost photo transistors is incorporated to replace the high cost optic image detection device so as to reduce the maintenance costs of the optic tracking device.

To achieve the above objects, in accordance with the present invention, there is provided an optic tracking device comprising a movable body having a bottom movably supported on a pad. The bottom of the body defines a cavity for accommodating an optic sensor comprised of a number of photo transistors encased in a transparent casing. A light emitting element is mounted in the body to project light to the pad at a position substantially below the optic sensor. The light is reflected by the pad and detected by the optic sensor. The pad forms a number of light reflective zones spaced from each other and surrounded by a light absorbing area whereby when the body is moved on the pad, light reflected from the pad and detected by the optic sensor changes with the movement of the body that alternately passes through the light reflective zones and different portions of the light absorbing area. The optic sensor converts the light reflected from the pad into an electrical signal which is processed by a signal processing circuit to generate data corresponding to moving speed and direction of the body.

### BRIEF DESCRIPTION OF THE DRAWINGS

The present invention will be apparent to those skilled in the art by reading the following description of preferred embodiment thereof, with reference to the attached drawings, in which:

FIG. 1 is a perspective view of an optic tracking device constructed in accordance with the present invention with a movable body separated from a pad for illustration purposes;

FIG. 2 is an exploded view of the optic tracking device of the present invention;

FIG. 3 is a cross-sectional view of the optic tracking device of the present invention;

FIG. 4 is a block diagram of a signal processing circuit of the optic tracking device of the present invention;

FIG. 5 is a circuit diagram of a signal conversion device of the signal processing circuit of FIG. 4;

FIG. 6 is a plot showing an illustrative example of input signal of the signal conversion device; and

FIG. 7 is plot showing an illustrative example of output signal of the signal conversion device.

### DETAILED DESCRIPTION OF THE PREFERRED EMBODIMENTS

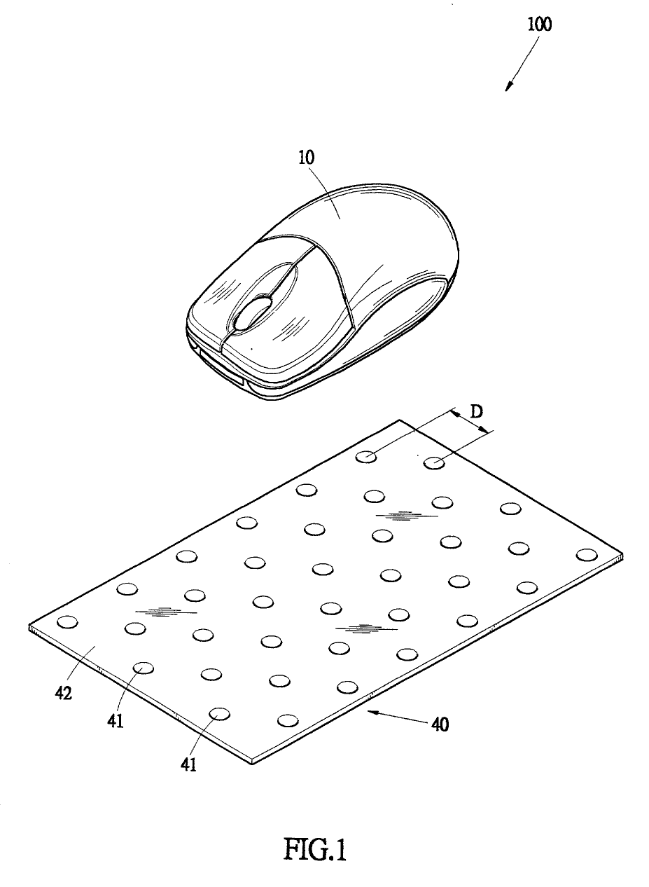

With reference to the drawings and in particular to FIGS. 1-3, an optic tracking device constructed in accordance with the present invention, generally designated with reference numeral 100, comprises a movable body 10, an optic sensor 20, a light emitting element 30, a pad 40 and a signal processing circuit 50. The movable body 10 can be of any type and shape that is capable to be handled by a user's hand. In the embodiment illustrated, the body 10 is made in the form of a regular computer mouse. A cavity 11 is defined in a bottom (not labeled) of the body 10 for accommodating the optic sensor 20.

The optic sensor 20 comprises a number of photo transistors 21 encased in a transparent casing 22. The photo transistors 21 are fixed together inside the casing 22. The photo transistors 21 can be arranged in any manner, such as a hexagonal configuration in the embodiment illustrated for detecting light from all directions.

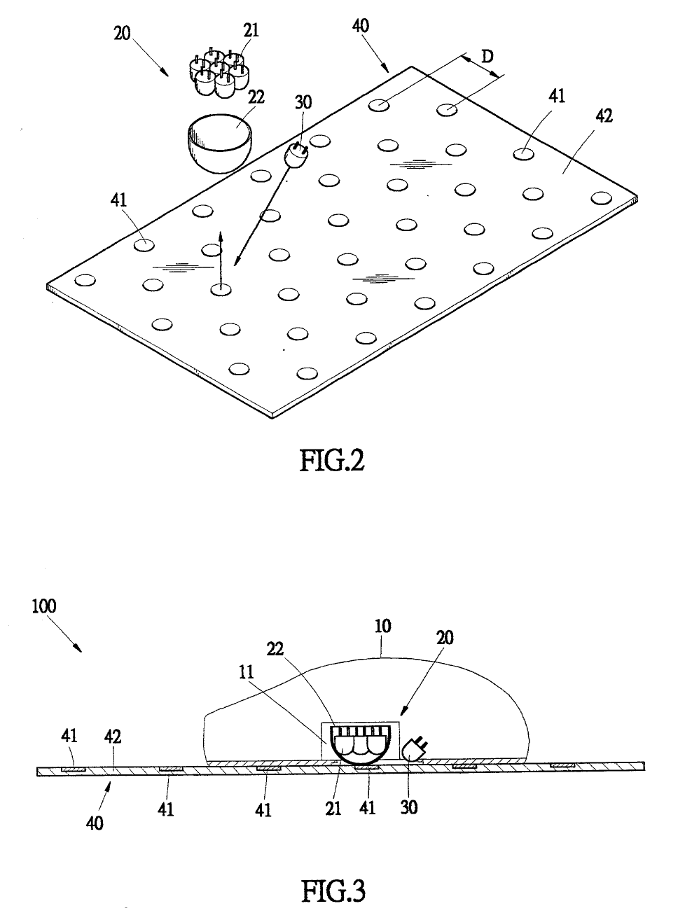

The light emitting element 30 is arranged inside the body 10 proximate the optic sensor 20, as shown in FIGS. 2 and 3 for projecting light in an inclined direction onto a position substantially below the optic sensor 20 to have the light reflected by the pad 40 back onto the optic sensor 20. The light emitting element 30 can be any device that can project light as described. In the embodiment illustrated, the light emitting element 30 is a light emitting diode.

The body 10 is movably supported on the pad 40 with the bottom of the body 10 in physical engagement with the pad 40. A number of discrete and spaced zones 41 of high reflectivity are formed on the pad 40. The light reflective zones 41 can be of any shape and are substantially circular in the embodiment illustrated. Adjacent ones of the light reflective zones 41 are spaced by a light absorbing area 42 with a known distance D between the light reflective zones 41. The light absorbing area 42 surrounds the light reflective zones 41. In this respect, the pad 40 is made of a light absorbing material with the light reflective zones 41 substantially uniformly distributed on the light absorbing pad 40. When the body 10 is moved on the pad 40, the optic sensor 20 undergoes alternate activation/deactivation by the alternate arrangement of light reflective zones 41 and the light absorbing areas 42 along the path that the body 10 moves.

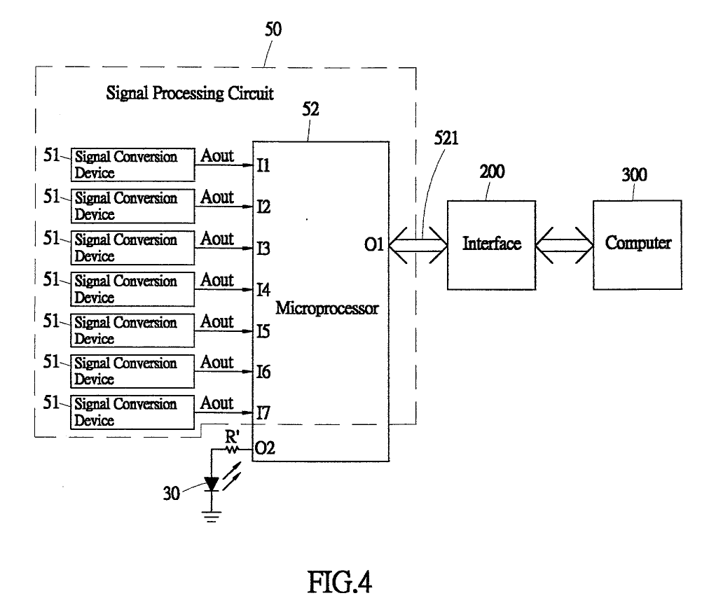

Also referring to FIGS. 4-6, the signal processing circuit 50 is arranged inside the body 10 and comprises a microprocessor 52 and a number of signal conversion devices 51 respectively connecting the photo transistors 21 to corresponding input terminals I1-I7 of the microprocessor 52. A primary electrical signal Ain generated by each photo transistor 21 is processed by the associated signal conversion device 51 to generate an output electrical signal or a secondary electrical signal Aout which is applied to the corresponding input terminal I1-I7 of the microprocessor 52. The microprocessor 52 processes the secondary electrical signals Aout of the signal conversion devices 51 and generates an output signal 521 at an output terminal O1 thereof for indicating a moving vector of the body 10 with respect to the pad 40.

The primary electrical signal Ain is generated by each photo transistor 21 by detecting the light reflective zones 41 and/or the light absorbing area 42. The primary electrical signal Ain is related to the optic flux of the light received by the photo transistor 21. In other words, the primary electrical signal Ain has a higher voltage level when the photo transistor 21 is located closer to the light reflective zone 41 and the primary electrical signal Ain is reduced when the photo transistor 21 is moving away from the light reflective zone 41. Thus, the primary electrical signal Ain is generally an analog signal. For simplicity of description, the primary electrical signal Ain is assumed to be a sinusoidal wave in the illustration herein.

The signal conversion devices 51 each comprises a current-limiting resistor R connected between collector 211 of the photo transistor 21 and a power source Vcc for limiting electrical current flowing through the photo transistor 21. When the photo transistor 21 detects an input light signal generated by the light emitting element 30, the primary electrical signal Ain is formed in the collector gate 211 of the photo transistor 21. The signal conversion device 51 also comprises first and second operational amplifiers OP1, OP2 having positive input terminals X1, Y1, respectively, connected together and to the collector 211 of the photo transistor 21 whereby the primary electrical signal Ain of the photo transistor 21 is applied to the positive input terminals X1, Y1 of the operational amplifiers OP1, OP2 simultaneously. An output terminal X3 of the first operational amplifier OP1 is connected to a negative input terminal X2 of the operational amplifier OP1. A negative input terminal Y2 of the second operational amplifier OP2 is connected to the output terminal X3 of the first operational amplifier OP1. An output terminal Y3 of the second operational amplifier OP2 is connected to the corresponding input terminal I1-I7 of the microprocessor 52.

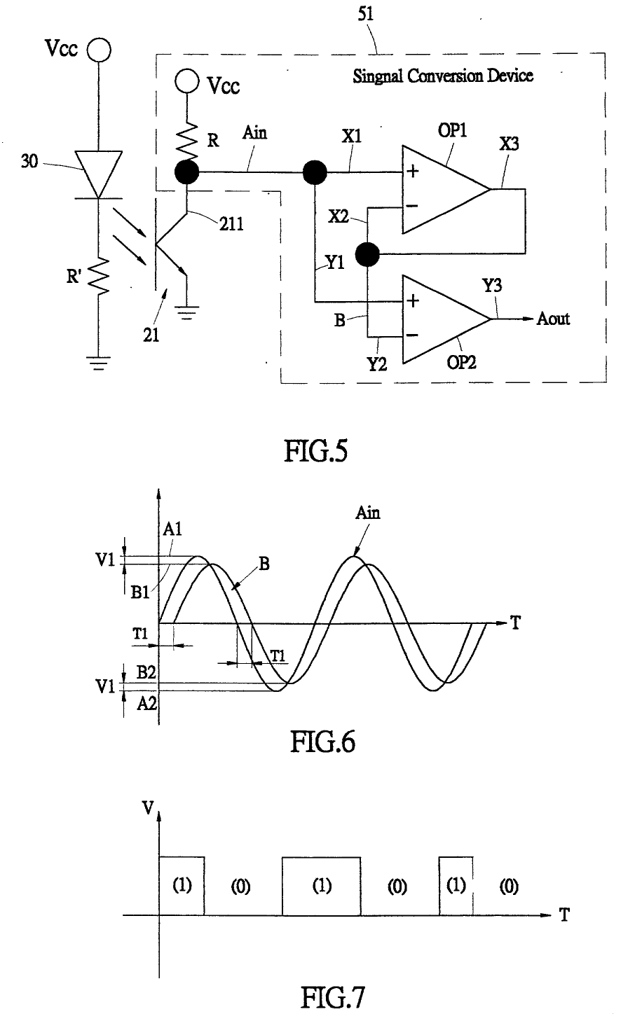

The first operational amplifier OP1 is made to have a hysteresis voltage of VI (FIG. 6) and the second operational amplifier OP2 has a hysteresis voltage of approximately 0.2 Volts. The hysteresis voltages of the first and second operational amplifiers OP1, OP2 indicates the hysteresis of the output signal with respect to the input signal thereof. This is known to those having ordinary skills in the art of electronics. The hysteresis voltage V1 of the first operational amplifier OP1 can have any suitable value of which an example is 0.8 volts. The hysteresis voltages of the operational amplifiers OP1, OP2 allow the signal conversion device 51 to quickly and precisely capture a small variation of voltage of the primary electrical signal Ain.

FIG. 6 shows a plot of the primary electrical signal Ain and a corresponding intermediate stage signal or delayed reference signal B at the output terminal X3 of the first operational amplifier OP1. Abscissa of the plot indicates time, while ordinate indicates voltages. The positive and negative peak values A1 and A2 of the primary electrical signal Ain are reduced a value corresponding to the hysteresis voltage V1 of the first operational amplifier OP1 as indicated by the positive and negative peak values B1 and B2 of the intermediate stage signal B shown in FIG. 6. The intermediate stage signal B also has a phase lag of T1. This is known and no further detail is needed.

The intermediate stage signal B is then applied to the negative input terminal Y2 of the second operational amplifier OP2. The secondary electrical signal Aout is generated at the output terminal Y3 of the second operational amplifier OP2 that is a series of square waves as shown in FIG. 7. Such square waves are obtained by comparison between the primary electrical signal Ain and the intermediate stage signal B as is apparent to those having ordinary skills in the field of electronics. Abscissa and ordinate of the plot of FIG. 7 are respectively time and voltages.

It is noted that the secondary electrical signal Aout generated by each signal conversion device 51 is, in general, different from each other. This is due to the relative position of each photo transistor 21 with respect to a particular light reflective zone 41 is different from each other. The time interval covered by the square waves in the plot of FIG. 7 that is marked “(1)” is apparently the time period when the particular photo transistor 21 is located at a position close to a light reflective zone 41 of the pad 40, while that marked “(0)” indicates the particular photo transistor 21 is moved to a location away from the light reflective zone 41. The series of square waves of the secondary electrical signal Aout provides information related to the relative position of the photo transistor 21 with respect to an adjacent light reflective zone 41.

The secondary electrical signal Aout of each signal conversion device 51 is applied to the corresponding input terminal I1-I7 of the microprocessor 52 of the signal processing circuit 50. Based on the difference between the secondary electrical signals Aout received at the input terminals I1-I7, as well as the distance D between adjacent light reflective zones 41 of the pad 40, the microprocessor 52 calculates out the moving speed and direction. An output signal or data 521 representing the calculation result of the microprocessor 52 is then presented at the output terminal O1 of the microprocessor 52.

Referring back to FIG. 4, the signal 521 is processed by an interface circuit 200 and then applied to a computer 300. The interface circuit 200 can be any known interface between a computer and a tracking device, such as a PS/2 interface and a USB (Universal Serial Bus) interface. The computer 300 can make use of the signal 521 to control the movement of a cursor displayed in an associated display screen whereby the movement of the cursor is corresponding to that of the tracking device 100.

In practice, the light emitting element 30 is connected to a second output terminal O2 of the microprocessor 52 via a current-limiting resistor R′ for controlling the activation/deactivation of the light emitting element 30.

It is apparent that the optic tracking device 100 of the present invention has a simple and less costly structure. The manufacturing and maintenance costs can thus be reduced. The incorrect or random movement of the cursor caused by improperly positioning/orienting the conventional optic mouse can be eliminated by the optic tracking device of the present invention which generates no output signal for driving the cursor when it is improperly positioned/oriented. Hence, the cursor is maintained still when the optic tracking device of the present invention is improperly positioned/oriented.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An optic tracking device for controlling a cursor of a computer display, the optic tracking device comprising:
a pad having a surface on which a number of light reflective zones are formed and spaced from each other by light absorbing zones;
a body movable on the surface of the pad, the body having a bottom positioned on the surface of the pad and defining a cavity;
a light emitting element adapted to project a light onto the pad whereby the light is selectively reflected by the light reflective zones and absorbed by the light absorbing zones;
an optic sensor received in the cavity, the optic sensor comprising a number of photo transistors arranged in a predetermined pattern for detecting an optic signal caused by the reflected light in different directions and each generating a primary electrical signal corresponding to the detection;
a signal processing circuit having input terminals respectively connected to the photo transistors to receive the primary electrical signals of the photo transistors, the primary electrical signals being processed by the signal processing circuit to generate an output signal indicating moving speed and direction of the body with respect to the pad.

2. The optic tracking device as claimed in claim 1, wherein the optic sensor comprises a transparent casing encasing the photo transistors.

3. The optic tracking device as claimed in claim 1, wherein the light emitting element comprises a light emitting diode.

4. The optic tracking device as claimed in claim 1, wherein the signal processing circuit comprises:
a signal conversion circuit connected to each photo transistor to receive the primary electrical signal and generating a secondary electrical signal; and
a microprocessor having input terminals to which the secondary electrical signals are applied and an output terminal, the microprocessor performing a predetermined operation to process the secondary electrical signals for generation of an output signal that indicates the moving speed and direction of the movable body at the output terminal thereof.

5. The optic tracking device as claimed in claim 4, wherein each secondary electrical signal comprises a series of square waves.

6. The optic tracking device as claimed in claim 4, wherein the signal conversion circuit comprises first and second operational amplifiers having first and second positive input terminals connected to the photo transistor to receive the primary electrical signal, the first operational amplifier having a first negative input terminal coupled to a first output terminal thereof for generation of a delayed reference signal at the first output terminal, the second operational amplifier having a second negative input terminal coupled to the first output terminal to receive the delayed reference signal and a second output terminal for generation of the secondary electrical signal based on comparison between the primary electrical signal and the delayed reference signal.

7. The optic tracking device as claimed in claim 6, wherein each operational amplifier has hysteresis characteristics of the output terminal with respect to the positive input terminal thereof.

8. The optic tracking device as claimed in claim 6, wherein the secondary electrical signal comprises a series of square waves.

9. The optic tracking device as claimed in claim 6, wherein the signal conversion circuit further comprises a current-limiting resistor adapted to be connected between the photo transistor and a power source for limiting electrical current flowing through the photo transistor.

10. The optic tracking device as claimed in claim 4, wherein the microprocessor has an additional output terminal to which the light emitting element is connected for controlling actuation of the light emitting element.
